(19) United States
(12) Patent Application Publication
(10) Pub. No.: US 2024/0388096 A1
(43) Pub. Date: Nov. 21, 2024

(54) ELECTRIC POWER CONTROL SYSTEM

(71) Applicant: NTT DOCOMO, INC., Tokyo (JP)

(72) Inventors: Masaki NAKAMURA, Chiyoda-ku (JP); Yuta TOYAMA, Chiyoda-ku (JP); Kazuhiko TAKENO, Chiyoda-ku (JP)

(73) Assignee: NTT DOCOMO, INC., Tokyo (JP)

(21) Appl. No.: 18/692,507

(22) PCT Filed: Sep. 9, 2022
(86) PCT No.: PCT/JP2022/033941

§ 371 Date: Mar. 15, 2024

(30) Foreign Application Priority Data
Oct. 22, 2021 (JP) 2021-173265

(51) Int. Cl. H02J 3/32; H02J 3/14; H02J 13/00

(52) U.S. Cl. CPC H02J 3/32; H02J 3/14; H02J 13/00002

(57) ABSTRACT

An electric power control system (1) includes: a plurality of base stations (20) which are a plurality of consumers including a communication device (70) as a load, a rectifier (50) and a storage battery (60); and a control unit (2) controlling the rectifier (50) and the storage battery (60) in the plurality of consumers, and the system (1) performs a power saving operation in the plurality of consumers based on a power saving request. Here, the control unit (2) divides a time zone in which the power saving request is made into a plurality of unit times (intervals), selects a consumer to be subjected to power saving control from the plurality of consumers based on a power saving request amount per unit time, and performs a discharge operation from the storage battery (60) in the selected consumer, thereby responding to the power saving request.

### TECHNICAL FIELD

One aspect of the present disclosure relates to an electric power control system.

### BACKGROUND ART

In recent years, demand response (DR) has attracted attention as a method of adjusting electric power supply and demand from electric power suppliers to consumers while the utilization rate of natural energy in electric power suppliers has increased. Since an amount of electric power generation by solar electric power generation or wind electric power generation using natural energy increases or decreases according to weather (solar radiation, wind volume, etc.), a method of flexibly adjusting an amount of electric power supply and demand by requesting DR from a consumer is adopted, and the consumer is requested to save power by designating a power saving amount. On the other hand, consumers have studied an electric power control method for performing a DR response. For example, Patent Literature 1 discloses a method of distributing a limited electric power distribution amount to a plurality of consumers while considering storage amounts of storage batteries owned by the plurality of consumers when responding to DR.

### CITATION LIST

### Patent Literature

Patent Literature 1: Japanese Unexamined Patent Publication No. 2018-33273

### SUMMARY OF INVENTION

### Technical Problem

Meanwhile, there is a possibility that the demand for the power saving amount to the consumer changes from moment to moment. On the other hand, since the power consumption amount in the load of the consumer can also change, it is assumed that the situation in which the power saving request can be satisfied is not continued depending on the consumer.

The present disclosure has been made in view of the above, and an object of the present disclosure is to provide a technique capable of flexibly responding to a power saving request while considering a power usage situation in a plurality of consumers.

### Solution to Problem

An electric power control system according to one aspect of the present disclosure includes: a plurality of consumers including a load, a rectifier, and a storage battery; and a control unit configured to control the rectifier and the storage battery in the plurality of consumers, the electric power control system performing a power saving operation in the plurality of consumers based on a power saving request, in which the control unit divides a time zone in which the power saving request is made into a plurality of unit times, selects a consumer to be subjected to power saving control from the plurality of consumers based on a power saving request amount per unit time, and performs a discharge operation from the storage battery in the selected consumer to respond to the power saving request.

In such an aspect, even in a case where the power saving request amount changes depending on the time zone in the power saving request, the consumer to be subjected to the power saving control is selected from the plurality of consumers based on the power saving request amount per unit time. Then, the selected consumer performs a discharge operation from the storage battery. Therefore, it is possible to flexibly respond to a power saving request in which the power saving request amount fluctuates. Furthermore, since a consumer to be subjected to power-saving control is selected from the plurality of consumers and the discharge operation from the storage battery is performed, it is possible to determine whether or not to perform the discharge operation according to a situation of each of the consumers.

### Advantageous Effects of Invention

According to one aspect of the present disclosure, there is provided a technology capable of flexibly responding to a power saving request while considering an electric power usage situation in the plurality of consumers.

### BRIEF DESCRIPTION OF DRAWINGS

FIG. 1 is a diagram illustrating an example of a schematic configuration of an electric power control system according to an embodiment.

FIG. 2 is a diagram illustrating an example of a functional configuration of a control unit in an electric power control system according to a first embodiment.

FIG. 3 is a diagram for explaining an example of a relationship between a power saving request amount and a power saving amount.

FIG. 4 is a flowchart illustrating an example of an electric power control method according to the first embodiment.

FIG. 5 is a diagram illustrating an example of a functional configuration of a control unit in an electric power control system according to a second embodiment.

FIG. 6 is a flowchart illustrating an example of an electric power control method according to the second embodiment.

FIG. 7 is a diagram illustrating an example of a hardware configuration of a computer used in an electric power control system.

### DESCRIPTION OF EMBODIMENTS

Hereinafter, embodiments for carrying out the present disclosure will be described in detail with reference to the accompanying drawings. Note that, in the description of the drawings, the same elements are denoted by the same reference signs, and redundant description will be omitted.

### First Embodiment

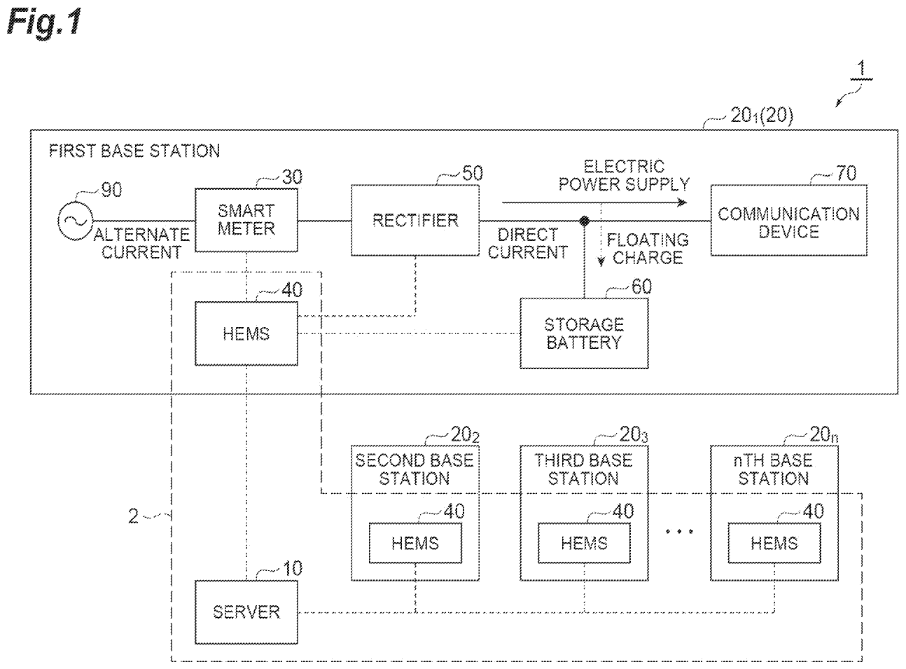

As illustrated in FIG. 1, an electric power control system 1 including an electric power control system according to a first embodiment is a so-called distributed electric power supply system that controls electric power of a plurality of (n) base stations 20 (first base station 20₁, second base station 20₂, third base station 20₃, . . . nth base station 20ₙ) by a server 10. In FIG. 1, the configuration of the base station 20 will be described with reference to the first base station 20₁, but other base stations have similar configurations.

Each of the base stations 20 includes a smart meter 30, a home energy management system (hereinafter referred to as “HEMS”) 40, a rectifier 50, a storage battery 60 for backup during power failure of a commercial electric power supply, and a communication device 70 (hereinafter referred to as “load” in some cases) that consumes a direct current. Alternate current from a commercial electric power supply 90 is input to the rectifier 50 via the smart meter 30 and converted into a direct current by the rectifier 50. The converted direct current is supplied to the communication device 70 and the storage battery 60. The HEMS 40 acquires commercial electric power information from the smart meter 30, a measurement value from a sensor (for example, a current measurement unit and a bus voltage measurement unit) or the like that can be provided in the rectifier 50, and information on a state of charge (hereinafter referred to as “SOC”) from the storage battery 60. Examples of the information from the sensor provided in the rectifier 50 include a value of a current flowing to the communication device 70, a bus voltage value in a bus to which a direct current is supplied to the communication device 70, and the like. Furthermore, the HEMS 40 has a function of giving a setting command of a rectifier voltage to the rectifier 50 and causing the rectifier 50 to execute a desired operation. Note that the setting command of the rectifier voltage corresponds to a control command related to charging and discharging of the storage battery 60.

In each base station 20, the current in the base station 20 is adjusted by the above-described HEMS 40. Furthermore, the HEMS 40 notifies the server 10 of the electric power status in the base station 20 in which own device is provided, and adjusts each unit in the base station 20 based on an instruction from the server 10. In this manner, the server 10 communicates with the HEMS 40 provided in each base station 20, and confirms the operation status of electric power in each base station 20. Furthermore, based on a power saving request such as a demand response (DR) request to the electric power control system 1, the server 10 has a function of determining whether or not to respond to the power saving request in each base station 20 based on the electric power operation status in each base station 20 and, based on a result thereof, giving a command to charge and discharge the storage battery corresponding to the power saving request to the HEMS 40 provided in each base station 20.

In the electric power control system 1 described above, each base station 20 corresponds to a so-called “consumer” (electricity consumer). Then, the server 10 and the HEMS 40 have a function as the control unit 2 that controls the operation of electric power at a plurality of the consumers.

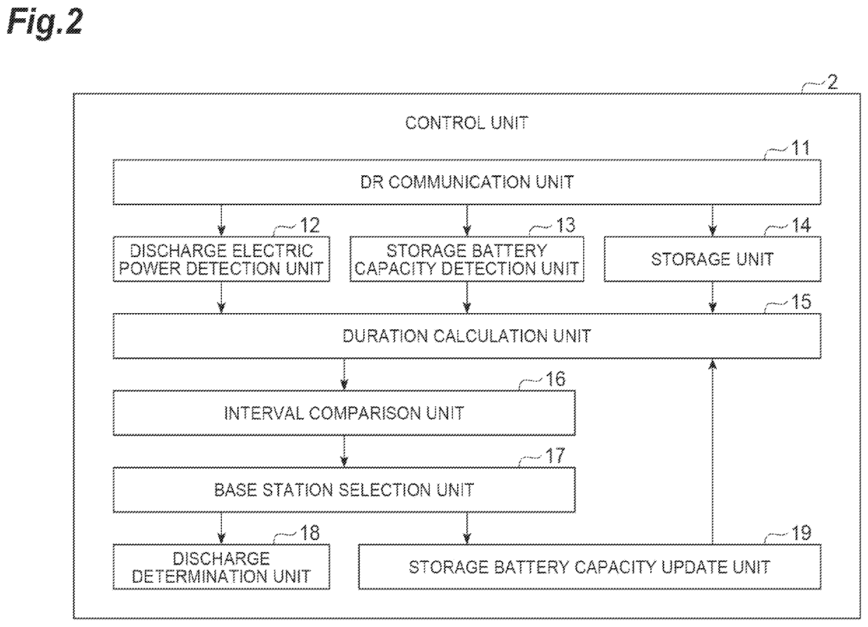

Next, the functions of the server 10 and the HEMS 40 that function as the control unit 2 will be described with reference to FIG. 2. Note that, in FIG. 2, the functions as the control unit 2 are collectively illustrated as one, but as described above, the functions as the control unit 2 are distributed and arranged in the server 10 and the HEMS 40.

The control unit 2 includes a DR communication unit 11, a discharge electric power detection unit 12, a storage battery capacity detection unit 13, a storage unit 14, a duration calculation unit 15, an interval comparison unit 16, a base station selection unit 17, a discharge determination unit 18, and a storage battery capacity update unit 19. These functions are basically provided in the server 10, and some of the functions can be distributed and arranged in the HEMS 40.

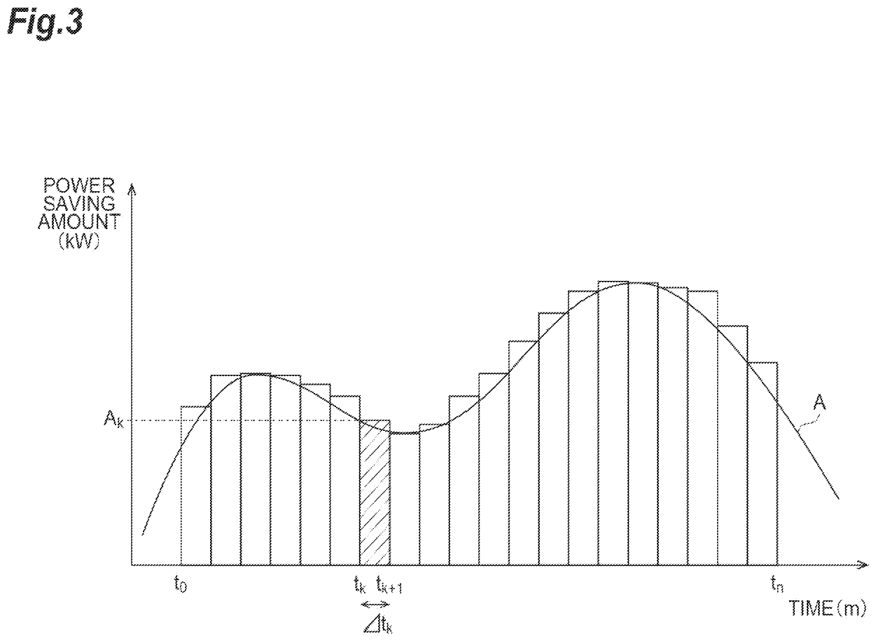

Before describing each unit of the control unit 2, an “interval” used in the electric power control system 1 according to the present embodiment will be described, and control contents by the server 10 and the HEMS 40 that function as the control unit 2 will be described with reference to FIG. 3.

In the electric power control system 1, a total amount of power saving by all the base stations 20 is adjusted based on the power saving request. In FIG. 3, a power saving request amount A for the electric power control system 1 is indicated by a curve. As illustrated in FIG. 3, the electric power control system 1 according to the present embodiment assumes a case where the power saving request amount changes with time, and sets a unit time called an interval to perform management for each unit time. In the example illustrated in FIG. 3, a time zone from time t=0 to T in which a power saving request occurs is divided into a plurality of sections (for example, n sections), and the dividing time is defined as time tₖ (k=0 to n). At this time, time t=0 is set as time t₀, and time T is set as time tₙ. Furthermore, a time zone of each section is set as an interval Δtₖ (k=0 to n−1). The interval Δtₖ corresponds to a section of t=tₖ to tₖ₊₁. A time width of the interval Δtₖ can be several minutes to several hours. Furthermore, a length of the interval Δtₖ may not be constant, and for example, may be appropriately set according to the fluctuation of a power saving request amount A.

In each interval Δtₖ, the total amount of power saving amounts by all the base stations 20 is set as a maximum value of the power saving request amount A in the section. For example, since the power saving request amount A gradually decreases in one interval Δtₖ exemplified in FIG. 3, the power saving amount in the period is set so as to be a power saving amount corresponding to the initial power saving request amount Aₖ in the period of the interval Δtₖ. Then, the base station 20 that responds to the power saving request is selected from all the base stations in units of the interval Δtₖ. Specifically, the base station 20 that can respond to the power saving request is selected based on a storage amount of the storage battery 60 in each base station 20 and a power consumption amount in the load (communication device 70) in cach base station 20. In this way, in the electric power control system 1, in a case where the power saving amount in the power saving request fluctuates, control is performed so that the storage amount in the storage battery 60 does not excessively decrease while appropriately responding to the power saving request.

Returning to FIG. 2, each unit constituting the control unit 2 will be described. The DR communication unit 11 is a device such as an electric power supplier, and has a function of communicating with an external device that issues a DR command to the electric power control system 1. Specifically, the DR communication unit 11 has a function of receiving a DR command from the electric power supplier or the like, and transmits B route data of the smart meter necessary for a DR performance report to the electric power supplier or the like.

The discharge electric power detection unit 12 has a function of acquiring output electric power from the rectifier 50. The discharge electric power detection unit 12 may be implemented as, for example, a function of the HEMS 40.

The storage battery capacity detection unit 13 has a function of acquiring a current storage battery capacity from the storage battery 60. The storage battery capacity detection unit 13 may be implemented as, for example, a function of the HEMS 40.

The storage unit 14 has a function of storing information related to a backup capacity of a storage battery for disaster to be secured by each base station 20. The storage unit 14 may be provided in the HEMS 40 of each base station 20, or may hold information of all the base stations 20 under management in the server 10.

The duration calculation unit 15 has a function of calculating a duration in a case where discharge from the storage battery 60 of each base station 20 is continued based on a specific time. Although a detailed procedure will be described later, a calculation result by the duration calculation unit 15 is used to determine whether power saving control can be performed in the base station 20.

The interval comparison unit 16 has a function of comparing a time during which a discharge state, which is the calculation result by the duration calculation unit 15, can be sustained, and a unit time (interval) in which power saving control is required. In a case where the time during which the discharge state can be sustained is longer than the interval, the base station 20 including the storage battery 60 can perform control responding to the power saving request for the interval.

The base station selection unit 17 has a function of selecting a base station group that can participate in the control responding to the power saving request from the base stations 20 under management based on the comparison result by the interval comparison unit 16.

The discharge determination unit 18 has a function of determining discharge from the storage battery 60 for the base station 20 that performs the control responding to the power saving request for the base station group selected by the base station selection unit 17, and executing specific control for responding to the power saving request.

The storage battery capacity update unit 19 has a function of updating storage battery capacity information regarding the capacity of the storage battery 60 of the base station 20 that participated in the power saving control by an amount of discharge assumed in the participating time zone (interval). In a case where the information on the storage battery capacity from the storage battery 60 is repeatedly acquired and the base station 20 corresponding to the response to the power saving request for only one interval is selected, this process by the storage battery capacity update unit 19 is unnecessary. However, for a plurality of the consecutive intervals, selection of a base station for responding to a power saving request may be performed at a time. In such a case, it is possible to estimate the capacity of the storage battery 60 in the future (after a predetermined interval elapses) by performing the processing by cach unit while updating the information on the storage battery capacity of the storage battery 60 in the storage battery capacity update unit 19, and it is possible to appropriately select the base station 20 responding to the control related to power saving by using a result of the estimation.

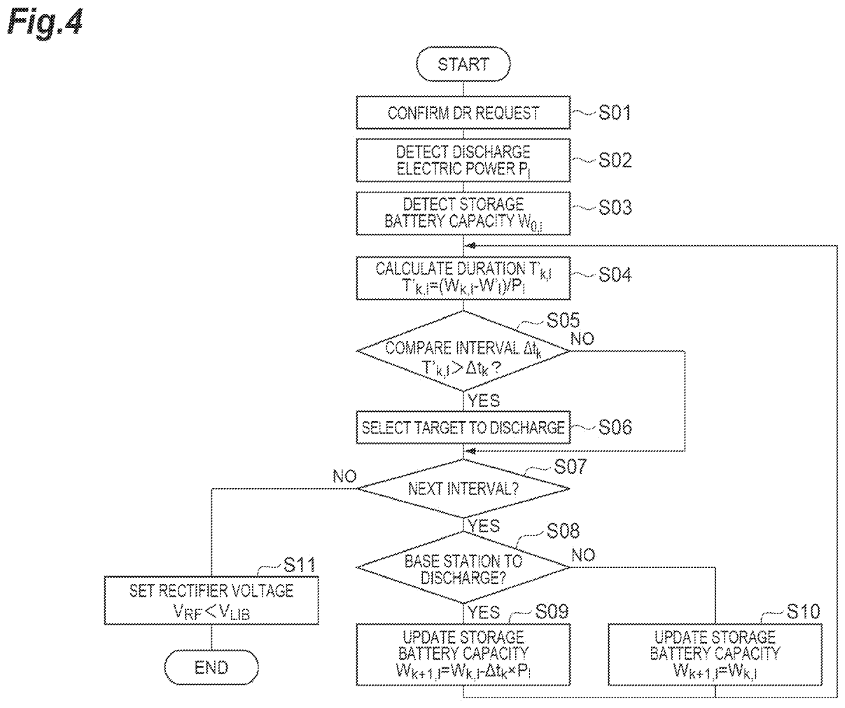

Next, a specific procedure (electric power control method) of processing by the control unit 2 will be described with reference to FIG. 4.

First, in step S01, the DR communication unit 11 receives a DR command from an electric power supplier or the like. Here, it is assumed that three stages of power saving requests are made in three periods as a DR request. Specifically, it is assumed that there is a power saving request of a period Δt₀: 10 kW, a period Δt₁: 20 kW, and a period Δt₂: 15 kW. When the DR communication unit receives the DR request, the DR communication unit 11 notifies the discharge electric power detection unit 12 and the storage battery capacity detection unit 13 of the DR request, and processing in steps S02 and S03 is performed.

First, in step S02, the discharge electric power detection unit 12 acquires output electric power Pₗ from the rectifier 50 in an l-th base station 20ₗ (l=1, 2, 3, . . . , n). On the other hand, in step S03, the storage battery capacity detection unit 13 acquires a current capacity W_{0,l} of the storage battery 60 from the storage battery 60 of the l-th base station 20ₗ.

Next, in step S04, the duration calculation unit 15 acquires a backup capacity W′ₗ of the storage battery 60 to be secured by the base station from the storage unit 14. The backup capacity is set in consideration of disaster or the like. The duration calculation unit 15 calculates a duration T′_{0,l} at a time k=0 using the output electric power Pₗ from the rectifier 50, the current capacity W_{0,l} of the storage battery 60, and the backup capacity W′ₗ of the storage battery 60 acquired from the storage unit 14. The duration is a time required for the capacity of the storage battery 60 to become the backup capacity in a case where all the current output electric power Pₗ is supplied from the storage battery 60 to the communication device 70. Therefore, the duration T′_{k,l} can be calculated by the following mathematical formula.

$${{T ’}_{k , 1} = ( {W}_{k , 1} - W ’}_{1} ) / {P}_{1}$$

In the case of k=0, the following is obtained.

$${{T ’}_{0 , 1} = ( {W}_{0 , 1} - W ’}_{1} ) / {P}_{1}$$

Next, in step S05, the interval comparison unit 16 determines whether or not the duration T′_{0,l} exceeds the interval Δt₀. In a case where the duration T′_{0,l} exceeds the interval Δt₀, that is, in a case where the discharge can be performed for a time longer than the interval Δt₀ (S05—YES), the l-th base station 20ₗ is regarded as a base station that can participate in the power saving control at the interval Δt₀.

On the other hand, in a case where the duration T′_{0,l} is shorter than or equal to the interval Δt₀ (S05—NO), the l-th base station 20ₗ is determined to be a base station incapable of participating in the power saving control at the interval Δt₀. In this case, since the base station is treated as a base station that does not participate in the power saving control, the base station is not selected as a discharge target base station, and thus is not included in the candidates of the base station selected in step S06 in the subsequent stage.

By performing the above procedure for each base station 20, participation/non-participation in the power saving control at the interval Δt₀ is determined for all the base stations 20 (20ₗ to 20_{N}).

Next, in step S06, the base station selection unit 17 selects the base station 20 that performs discharge so as to exceed the DR request amount of 10 kW at the interval Δt₀ from the base station group that can participate in the control. In a case where a total power-saving possible amount of the base station 20 group capable of the power-saving control can save more than 10 kW, the base station selection unit 17 may select the base station 20 to perform control such that the total power-saving amount becomes closer to the power-saving request amount of 10 kW. Furthermore, the base station 20 having a larger current capacity of the storage battery 60 may be configured to preferentially save power. Furthermore, as a method of selecting an appropriate base station 20, an integer programming problem may be set and solved, and specifically, the base station 20 may be selected by solving a knapsack problem. In this manner, the method of selecting a base station by the base station selection unit 17 can be appropriately set.

Here, in step S07, the storage battery capacity update unit 19 checks whether there is the next interval (there is an interval requiring the power saving control). At this time, in a case where there is the next interval (there is an interval requiring the power saving control) (step S07—YES), in step S08, the subsequent processing is changed depending on whether or not the base station 20 is actually selected as a control target among the dischargeable base stations 20 in the storage battery capacity update unit 19, so that it is determined whether or not the base station 20 is selected as the control target. First, for the base station 20 selected to participate in the power saving control at the interval Δt₀ (S08—YES), a value obtained by subtracting an expected discharge amount (Δt₀×Pₗ) at the interval Δt₀ from W₀ for the storage battery capacity is updated as a storage battery capacity Wₗ expected at a time tₗ at step S09. That is,

$${W}_{k + 1 , 1} = {W}_{k , 1} - Δ {t}_{k} \times {P}_{1}$$

the above calculation is performed, and in the case of k=0, the following is obtained.

$${W}_{1 , 1} = {W}_{0 , 1} - Δ {t}_{0} \times {P}_{1}$$

On the other hand, the storage battery capacity of the base station 20 that is determined not to participate in the power saving control at the interval Δt₀ (S08—NO) is assumed to take over the previous value as W_{k+l,l}=W_{k,l}, here, W_{l,l}=W_{0,l} as shown in step S10.

Thereafter, k=1 is set, and then the base station 20 participating in the power saving control at an interval Δtₗ is selected. Specifically, the duration calculation unit 15 calculates a duration T′_{l,l} at a time k=1 (S04), and the interval comparison unit 16 determines whether or not the duration T′_{l,l} exceeds the interval Δtₗ (S05). Moreover, after the base station 20 that can participate in the power saving control at the interval Δtₗ is selected, the base station selection unit 17 selects the base station 20 that performs discharge so as to exceed the DR request amount of 20 kW at the interval Δtₗ from the group of base stations 20 that can participate in the control (S06).

Then, in a case where there is the next interval (in a case where there is an interval requiring the power saving control) (step S07—YES), the storage battery capacity update unit 19 updates a value obtained by subtracting an estimated discharge amount (Δtₗ×Pₗ) at the interval Δtₗ from Wₗ as an estimated storage battery capacity W₂ at time t₂ for the base station 20 assumed to participate in the power saving control (S08 to S10). Based on this result, a series of processing is further performed to select a base station group to be discharged so as to exceed the request amount of 15 kW at the interval Δt₂. As a result, the base station 20 that performs the power saving control is selected in order to respond to the DR request in the three sections. As described above, by repeating steps S04 to S10 according to the number of sections (intervals) in which the power saving control is performed, the base station 20 to be subjected to the power saving control can be selected for each section in which the power saving control is performed, and a discharge plan from the storage battery 60 to respond to the DR request is created.

According to the above procedure, the base station 20 participating in the power saving control (discharge control of the storage battery 60) is selected for each interval. In this way, when the discharge plan is made in the base station 20 at the DR activation time, it is determined in step S07 that the next interval does not exist (there is no interval at which the power saving control is required) (step S07—NO), and thus, the processing related to the selection of the base station as the power saving target ends. Then, in step S11, a discharge command is transmitted from the discharge determination unit 18 to each base station 20. Each base station 20 performs a discharging operation from the storage battery 60 at a predetermined time. As described in step S11, the discharge from the storage battery 60 is performed by setting a rectifier voltage V_{RF} (for example, 45 V) to be lower than a storage battery voltage V_{LIB} (for example, 48 V) based on an instruction from the HEMS 40. Based on the discharge plan, by performing the discharge operation on the base station 20 selected for each interval, a power saving operation for responding to the DR request is performed as the entire electric power control system 1.

### Second Embodiment

Next, an electric power control system according to a second embodiment will be described.

The electric power control system 1 according to the first embodiment assumes an electric power-saving operation based on the DR request. On the other hand, in the second embodiment, an electric power control system 1 can reduce a peak of the entire electric power demand in all base stations 20 by predicting the demand electric power in the plurality of base stations 20 arranged in a distributed manner. That is, it is assumed that the demand electric power is predicted and the electric power exceeding a predetermined amount is covered by the electric power in a storage battery 60 in the base station 20 instead of being purchased from the commercial electric power supply 90. With such a configuration, it is possible to suppress purchase of a predetermined amount or more of electric power. However, since there is a possibility that the prediction of the demand electric power does not coincide with an actual power consumption amount, it is also a feature of the second embodiment that a base station (buffer station) as a backup for performing the power saving control is set.

In order to realize the above configuration, functions of the server 10 and the control unit 2 of the HEMS 40 are partially different.

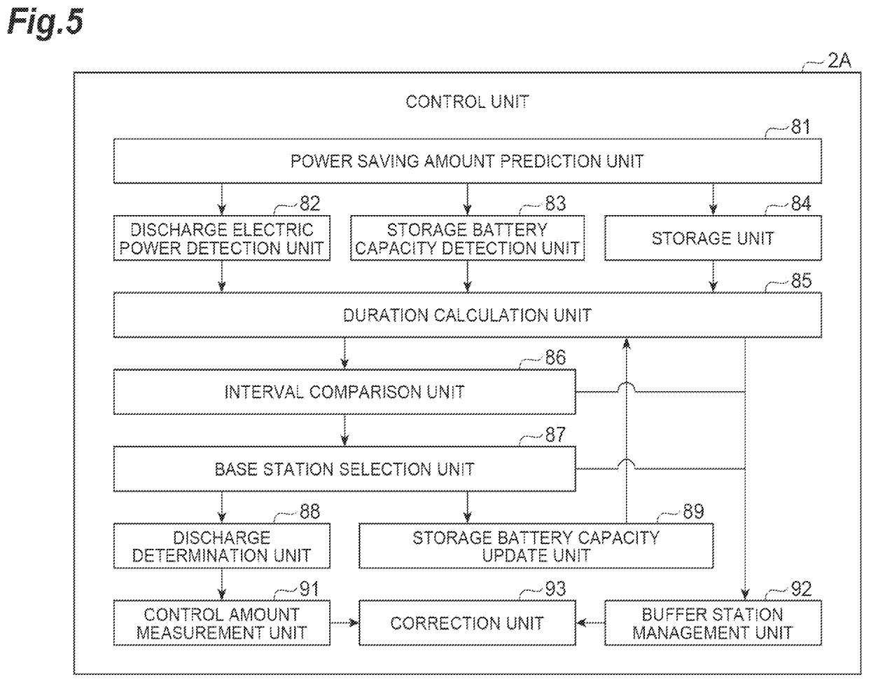

Functions of the server 10 and the HEMS 40 functioning as a control unit 2A in the electric power control system 1 according to the second embodiment will be described with reference to FIG. 5. Note that, in FIG. 5, the functions as the control unit 2A are collectively illustrated as one unit, but as described above, the functions as the control unit 2A are distributed and arranged in the server 10 and the HEMS 40.

The control unit 2A includes a power saving amount prediction unit 81, a discharge electric power detection unit 82, a storage battery capacity detection unit 83, a storage unit 84, a duration calculation unit 85, an interval comparison unit 86, a base station selection unit 87, a discharge determination unit 88, and a storage battery capacity update unit 89. The control unit 2A further includes a control amount measurement unit 91, a buffer station management unit 92, and a correction unit 93. The functions of the discharge electric power detection unit 82, the storage battery capacity detection unit 83, the storage unit 84, the duration calculation unit 85, the interval comparison unit 86, the base station selection unit 87, the discharge determination unit 88, and the storage battery capacity update unit 89 are basically similar to those of the discharge electric power detection unit 12, the storage battery capacity detection unit 13, the storage unit 14, the duration calculation unit 15, the interval comparison unit 16, the base station selection unit 17, the discharge determination unit 18, and the storage battery capacity update unit 19 in the control unit of the first embodiment, and thus the description thereof will be simplified.

The power saving amount prediction unit 81 predicts the demand electric power of each base station 20 by regression analysis or the like using prediction data of an ambient temperature and an actual value of the past demand electric power, and derives a prediction value of the entire demand electric power. As a result, electric power exceeding a predetermined threshold B is regarded as a power saving amount to be achieved. This makes it possible to contribute to the reduction of the demand peak in an area without a purchased electric power amount of the entire base station exceeding the threshold B. The power saving amount prediction unit 81 calculates a power saving amount for each interval. This point is similar to that of the first embodiment.

The discharge electric power detection unit 82 has a function of acquiring output electric power from the rectifier 50. The storage battery capacity detection unit 83 has a function of acquiring a current storage battery capacity from the storage battery 60. The storage unit 84 has a function of storing information related to a backup capacity of a storage battery for disaster to be secured by each base station 20.

The duration calculation unit 85 has a function of calculating a duration in a case where discharge from the storage battery 60 of each base station 20 is continued based on a specific time.

The interval comparison unit 86 has a function of comparing a time during which a discharge state, which is the calculation result by the duration calculation unit 85, can be sustained, and a unit time (interval) in which power saving control is required. In a case where the time during which the discharge state can be sustained is longer than the interval, the base station 20 including the storage battery 60 can perform the power saving control for the interval.

The base station selection unit 87 has a function of selecting a base station group that can participate in the control responding to the power saving request from the base stations 20 under management based on the comparison result by the interval comparison unit 86.

The discharge determination unit 88 has a function of executing control to instruct discharge from the storage battery 60 for the base station 20 that performs control responding to the power saving request for the base station group selected by the base station selection unit 87.

The storage battery capacity update unit 89 has a function of updating storage battery capacity information regarding the capacity of the storage battery 60 of the base station 20 that participated in the power saving control by an amount of discharge assumed in the participating time zone (interval).

The control amount measurement unit 91 has a function of monitoring the discharge control by the discharge determination unit 88 and monitoring whether the sum of the discharge electric power at a specific time is less than a power saving request amount derived from the demand prediction, that is, a power saving amount assumed at the time of prediction. Moreover, in a case where it is detected that the sum of the discharge electric power at the specific time is less than the power saving request amount derived from the demand prediction, the control amount measurement unit 91 specifies a difference therebetween as a control amount.

The buffer station management unit 92 has a function of selecting, by the base station selection unit 87, the base station 20 that executes discharge from the storage battery 60 at each interval, and then selecting and managing, as a buffer station, the base station 20 including the storage battery 60 having a capacity capable of discharging separately from the discharge based on the discharge plan.

The correction unit 93 has a function of performing discharge control by the control amount specified by the control amount measurement unit 91 using the storage battery 60 included in the buffer station selected by the buffer station management unit 92.

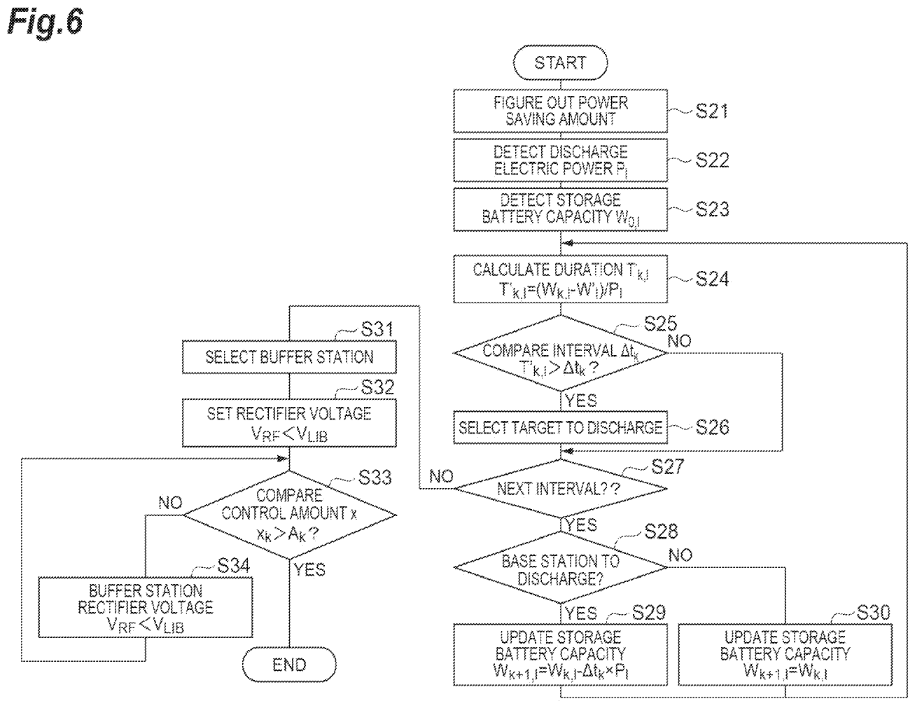

Next, a specific procedure of processing by the control unit 2A will be described with reference to FIG. 6.

First, in step S21, the power saving amount prediction unit 81 predicts a power saving amount as described above. As the power saving amount, different power saving amounts can be set in a plurality of periods (as an example, the intervals Δt₀ to Δt₃) similarly to the first embodiment. When the power saving amount prediction unit 81 calculates the power saving amount in each period (interval), a notification is given to the discharge electric power detection unit 82 and the storage battery capacity detection unit 83, and the processing of the next steps S22 and S23 is performed.

First, in step S22, the discharge electric power detection unit 82 acquires output electric power Pₗ from the rectifier 50 in an l-th base station 20₁ (l=1, 2, 3, . . . , n). On the other hand, in step S23, the storage battery capacity detection unit 83 acquires a current capacity W_{0,l} of the storage battery 60 from the storage battery 60 of the l-th base station 20ₗ.

Next, in step S24, the duration calculation unit 85 acquires a backup capacity W′ₗ of the storage battery 60 to be secured by the base station from the storage unit 84. The backup capacity is set in consideration of disaster or the like. The duration calculation unit 85 calculates a duration T′_{0,l} at a time k=0 using the output electric power Pₗ from the rectifier 50, the current capacity W_{0,l} of the storage battery 60, and the backup capacity W′ₗ of the storage battery 60 acquired from the storage unit 84. Similarly to the first embodiment, the duration T′_{k,l} can be calculated by the following mathematical formula.

$${{T ’}_{k , 1} = ( {W}_{k , 1} - W ’}_{1} ) / {P}_{1}$$

Next, in step S25, the interval comparison unit 86 determines whether or not the duration T′_{0,l} exceeds the interval Δt₀. In a case where the duration T′_{0,l} exceeds the interval Δt₀, that is, in a case where the discharge can be performed for a time longer than the interval Δt₀ (S25—YES), the l-th base station 20ₗ is regarded as a base station that can participate in the power saving control at the interval Δt₀. On the other hand, in a case where the duration T′_{0,l} is shorter than or equal to the interval Δt₀ (S25—NO), the l-th base station 20ₗ is determined to be a base station incapable of participating in the power saving control at the interval Δt₀. In this case, since the base station is treated as a base station that does not participate in the power saving control, the base station is not selected as a discharge target base station, and thus is not included in the candidates of the base station selected in step S26 in the subsequent stage.

By performing the above procedure for each base station 20, participation/non-participation in the power saving control at the interval Δt₀ is determined for all the base stations 20 (20ₗ to 20ₙ).

Next, in step S26, the base station selection unit 87 selects the base station 20 that performs discharge so as to exceed the power saving amount at the interval Δt₀ from the base station group that can participate in the control. The method of selecting a base station by the base station selection unit 87 can be appropriately set similarly to the first embodiment.

At step S27, the storage battery capacity update unit 89 checks whether there is the next interval (there is an interval requiring the power saving control). At this time, in a case where there is the next interval (there is an interval requiring the power saving control) (step S27—YES), in step S28, the subsequent processing is changed depending on whether or not the base station 20 is actually selected as a control target among the dischargeable base stations 20 in the storage battery capacity update unit 89, so that it is determined whether or not the base station 20 is selected as the control target. First, for the base station 20 selected to participate in the power saving control at the interval Δt₀ (S28—YES), a value obtained by subtracting an expected discharge amount (Δt₀×Pₗ) at the interval Δt₀ from W₀ for the storage battery capacity is updated as a storage battery capacity Wₗ expected at a time tₗ at step S29. That is, calculation is performed with k=0 along

$${W}_{k + 1 , 1} = {W}_{k , 1} - Δ {t}_{k} \times {P}_{1} .$$

On the other hand, the storage battery capacity of the base station 20 that is determined not to participate in the power saving control at the interval Δt₀ (S28—NO) is assumed to take over the previous value as W_{k+l,l}=W_{k,l}, here, W_{l,l}=W_{0,l} as shown in step S30.

Thereafter, k=1 is set, and then the base station 20 participating in the power saving control at an interval Δt₁ is selected. The specific procedure is the same as described above. Similarly to the first embodiment, by repeating steps S24 to S30 described above according to the number of sections (intervals) in which the power saving control is performed, the base station 20 to be subjected to the power saving control can be selected for each section in which the power saving control is performed, and a discharge plan from the storage battery 60 for achieving a desired power saving amount is created.

When the discharge plan is made in each base station 20, it is determined in step S27 that the next interval does not exist (there is no interval requiring the power saving control) (step S27—NO), and thus, the processing related to the selection of the base station as the power saving target ends.

Here, at step S31, the buffer station management unit 92 selects a buffer station. Specifically, even after the discharge plan is created based on a calculation result of the duration by the duration calculation unit 85, a comparison result with the interval by the interval comparison unit 86, and a selection result of the base station to be controlled by the base station selection unit 87, the base station 20 including the storage battery 60 in which a residual capacity of the storage battery 60 is larger than the backup capacity is set as the buffer station. A plurality of the buffer stations may be selected. In the base station 20 selected as the buffer station, normal operation is performed until control related to correction to be described later is performed.

Next, in step S32, a discharge command is transmitted from the discharge determination unit 88 to each base station 20. Each base station 20 performs a discharging operation from the storage battery 60 at a predetermined time. As described in step S11, the discharge from the storage battery 60 is performed by setting a rectifier voltage V_{RF} (for example, 45 V) to be lower than a storage battery voltage V_{LIB} (for example, 48 V) based on an instruction from the HEMS 40.

While the discharge operation is performed, the control amount measurement unit 91 monitors whether the discharge operation is properly performed. That is, at step S33, the control amount measurement unit 91 confirms a difference between a control amount xₖ, which is the sum of the discharge electric power at a time tₖ, and a power saving (discharge) request amount Aₖ at the time tₖ. Here, in a case where it is confirmed that the control amount xₖ, which is the sum of the discharge electric power at the time tₖ, is lower than the power saving request amount Aₖ at the time tₖ (S33—NO), a correction operation by the correction unit 93 is performed in step S34. That is, the correction unit 93 acquires information of the buffer station managed by the buffer station management unit 92. Then, the correction unit 93 selects a buffer station from the buffer station group so as to satisfy the power saving request amount Aₖ for the buffer station, and performs discharging. As a result, it is possible to perform control so as to discharge an electric power amount corresponding to a desired discharge amount. Note that when the control amount xₖ, which is the sum of the discharge electric power at the time tₖ, becomes equal to or larger than the power saving request amount Aₖ at the time tₖ (S33—YES), the correction unit 93 ends the discharge control of the buffer station and performs the discharge operation based on the discharge plan.

### Actions

The electric power control system 1 includes the plurality of base stations 20 that is the plurality of consumers including the communication device 70, which is a load, the rectifier 50, and the storage battery 60, and the control unit 2 (or the control unit 2A) that controls the rectifier 50 and the storage battery 60 in the plurality of consumers, and performs a power saving operation in the plurality of consumers based on a power saving request. Here, the control unit 2 divides a time zone in which the power saving request is made into a plurality of unit times (intervals), selects a consumer to be subjected to the power saving control from the plurality of consumers based on the power saving request amount per unit time, and performs a discharge operation from the storage battery 60 in the selected consumer, thereby responding to the power saving request.

With the above configuration, even in a case where the power saving request amount changes depending on a time zone in the power saving request, a consumer to be subjected to the power saving control is selected from the plurality of consumers based on the power saving request amount per unit time, that is, per interval. Then, the selected consumer performs the discharge operation from the storage battery 60. Therefore, it is possible to flexibly respond to a power saving request in which the power saving request amount fluctuates. Furthermore, since a consumer to be subjected to power-saving control is selected from the plurality of consumers and the discharge operation from the storage battery is performed, it is possible to determine whether to perform the discharge operation according to a situation of each of the consumers.

The control units 2 and 2A may acquire the output electric power information of the rectifier 50 and the current capacity information of the storage battery 60 in each of the plurality of consumers, and select a consumer to be subjected to the power-saving control based on these pieces of information. In a case where the power saving control is performed, it is necessary to discharge the storage battery 60. Therefore, by using the current capacity information of the storage battery 60, a consumer can be selected in consideration of the current capacity of the storage battery 60. Furthermore, the output electric power information of the rectifier 50 can be used to figure out how much electric power can be saved in a case where the consumer (base station 20) is selected as a target of power saving control. As described above, by using the output electric power information of the rectifier 50 and the current capacity information of the storage battery 60, it is possible to more appropriately figure out the situation of each consumer and appropriately select a consumer capable of the power saving control when selecting a consumer.

The control units 2 and 2A may select a consumer to be subjected to the power-saving control after securing the backup capacity of the storage battery 60 in each of the plurality of consumers. In this case, by performing the power saving control, the capacity of the storage battery 60 is prevented from falling below the backup capacity, and the power saving control can be performed in a state where the backup capacity is secured.

The control units 2 and 2A may compare the control amount related to the power saving among the plurality of consumers as a whole with the power saving request amount, and perform the discharge operation from the storage battery 60 in a consumer different from the consumer responding to the power saving request in a case where the control amount is insufficient for the power saving request amount. It is assumed that the power saving amount responding to the power saving request amount cannot be achieved although the power saving operation is performed as scheduled depending on the operating conditions (for example, variation in power consumption in the communication device 70 as a load) of each unit in the consumer. In this case, it is possible to achieve the power saving request amount by increasing the power saving amount by the discharge operation from the storage battery 60 in a consumer different from the consumer responding to the power saving request as described above. Therefore, the power saving operation based on the power saving request can be more appropriately performed.

The control units 2 and 2A may hold in advance information on a consumer different from the consumer responding to the power saving request and capable of performing a discharge operation from the storage battery. As an example, as in the control unit 2A described above, the information on the buffer station may be held in advance. In a case where the control amount is insufficient with respect to the power saving request amount, the consumer that performs the discharge operation from the storage battery 60 may be selected based on the information. As in the buffer station described in the above embodiment, in a case where information of a consumer different from the consumer who responds to a power saving request and a consumer who is capable of performing a discharge operation from the storage battery is held, when selecting a consumer who performs a discharge operation in order to achieve a power saving amount responding to the power saving request amount, it is possible to prevent erroneous selection of a consumer who has a problem in performing the discharge operation, such as a consumer with a small current capacity of the storage battery 60, and to execute the power saving operation based on the power saving request while stabilizing the electric power use state in each consumer.

As described in the first embodiment, the power saving request amount may be a power saving amount for responding to the demand response request. By performing the above control when responding to the demand response request, it is possible to appropriately respond to the demand response request while considering the electric power situation in each consumer.

Furthermore, as described in the second embodiment, the power saving request amount may be a request for reducing the demand peak based on the prediction of the electric power demand. When the demand peak of the electric power demand is large, there is a possibility that the electric power purchase amount as the entire electric power control system 1 increases. On the other hand, by performing the above control in order to reduce the demand peak as described above, it is possible to realize suppression of the demand peak while considering the electric power situation at each consumer.

Note that the configuration for selecting a buffer station and performing correction using the buffer station may also be applied to, for example, the response to the demand response request described in the first embodiment.

The electric power control system 1 also relates to a DC electric power control technology of a wireless base station as a technical field.

As another aspect of the electric power control system 1 and the electric power control method described above, there is a distributed power supply system (including a rectifier and a storage battery) or an electric power control method described below.

### Item 1

In a distributed power supply system including a rectifier and a storage battery, the distributed power supply system or an electric power control method includes a control unit that monitors and controls the rectifier and the storage battery for each base station, in which power saving control is performed by selecting a base station to participate in the control according to an increase or decrease in a required power saving amount.

### Item 2

In the distributed power supply system or the electric power control method of Item 1, an output voltage of the rectifier is adjusted to adjust a discharge amount of the storage battery.

### Item 3

In the distributed power supply system or the electric power control method of Item 1, a backup capacity at the time of disaster is secured by calculating a power saving amount for each base station from rectifier information and storage battery information.

### Item 4

In the distributed power supply system or the electric power control method of Item 1, a control amount of the entire base station and a power saving amount are compared during control, and when the control amount is insufficient, correction is performed by additionally discharging a base station that does not plan to participate in power saving.

### Item 5

In a distributed power supply system including a rectifier and a storage battery, the distributed power supply system or an electric power control method includes a control unit that monitors and controls the rectifier and the storage battery for each base station, in which a response to a demand response is made by selecting a base station so as to satisfy a request amount for each interval.

### Item 6

In the distributed power supply system or the electric power control method of Item 5, an output voltage of the rectifier is adjusted to adjust a discharge amount of the storage battery.

### Item 7

In the distributed power supply system or the electric power control method of Item 5, a backup capacity at the time of disaster is secured by calculating a respondable amount to the demand response for each base station from rectifier information and storage battery information.

### Item 8

In the distributed power supply system or the electric power control method of Item 5, a control amount of the entire base station and a request amount are compared during a demand response activation time, and when the control amount is insufficient, a base station that does not plan to participate in the demand response is additionally discharged.

### Others

Note that the block diagrams used in the description of the above embodiments illustrate blocks in units of functions. These functional blocks (configuration units) are realized by an arbitrary combination of at least one of hardware and software. Furthermore, a method of realizing each functional block is not particularly limited. That is, each functional block may be realized by using one physically or logically combined device, or may be realized by directly or indirectly (for example, by using wired, wireless, or the like,) connecting two or more physically or logically separated devices and using a plurality of these devices. The functional block may be realized by combining software with the one device or the plurality of devices.

The functions include, but are not limited to, determining, deciding, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating or mapping, assigning, and the like. For example, a functional block (component) that causes transmission to function is referred to as a transmitting unit or a transmitter. In any case, as described above, the implementation method is not particularly limited.

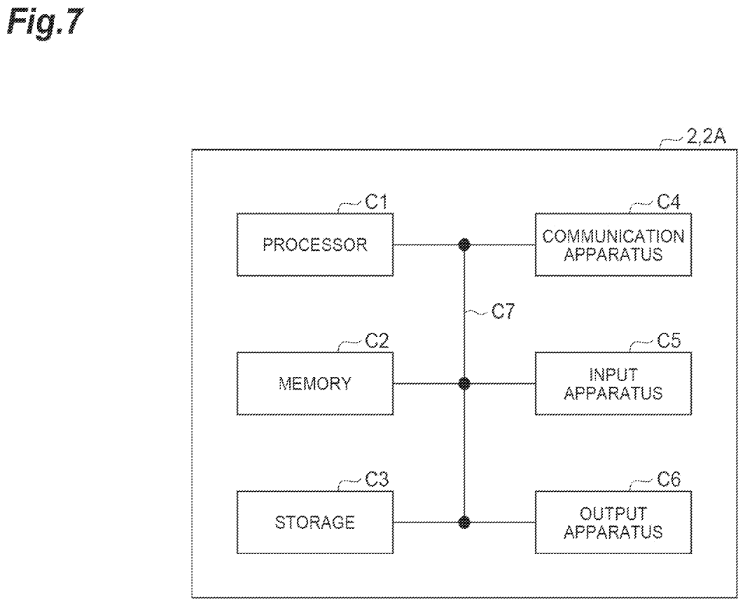

For example, the electric power control system 1 or the like in an embodiment of the present disclosure may function as a computer that performs the processing of the electric power control method of the present disclosure. FIG. 7 is a diagram illustrating an example of a hardware configuration of the electric power control system 1 according to an embodiment of the present disclosure. The above-described electric power control system 1 may be physically configured as a computer device including a processor C1, a memory C2, a storage C3, a communication apparatus C4, an input apparatus C5, an output apparatus C6, a bus C7, and the like.

Note that, in the following description, a term “apparatus” can be replaced with a circuit, a device, a unit, or the like. The hardware configuration of the control units 2 and 2A (server 10, HEMS 40) may be configured to include one or a plurality of apparatuses illustrated in FIG. 7, or may be configured without including some apparatuses.

Each function in the control units 2 and 2A (server 10, HEMS 40) is implemented by the processor C1 performing operation by loading predetermined software (program) on hardware such as the processor C1 and the memory C2, controlling communication by the communication apparatus C4, and controlling at least one of reading and writing of data in the memory C2 and the storage C3.

The processor C1 operates, for example, an operating system to control the entire computer. The processor C1 may be configured by a central processing unit (CPU) including an interface with a peripheral apparatus, a control apparatus, an operation apparatus, a register, and the like. For example, each unit and the like included in the control units 2 and 2A described above may be realized by the processor C1.

Furthermore, the processor C1 reads a program (program code), a software module, data, and the like from at least one of the storage C3 and the communication apparatus C4 to the memory C2, and executes various types of processing according to these. As the program, a program that causes a computer to execute at least part of the operations described in the above-described embodiments is used. For example, each unit included in the above-described control units 2 and 2A may be realized by a control program stored in the memory C2 and operated in the processor C1. Although it has been described that the above-described various processing is executed by one processor C1, the various processes may be executed simultaneously or sequentially by two or more processors C1. The processor C1 may be implemented by one or more chips. Note that the program may be transmitted from a network via an electric communication line.

The memory C2 is a computer-readable recording medium, and may be configured by, for example, at least one of a read only memory (ROM), an erasable programmable ROM (EPROM), an electrically erasable programmable ROM (EEPROM), a random access memory (RAM), and the like. The memory C2 may be referred to as a register, a cache, a main memory (main storage apparatus), or the like. The memory C2 can store a program (program code), a software module, and the like that can be executed to implement the wireless communication method according to the embodiment of the present disclosure.

The storage C3 is a computer-readable recording medium, and may include, for example, at least one of an optical disk such as a compact disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage C3 may be referred to as an auxiliary storage apparatus. The above-described storage medium may be, for example, a database including at least one of the memory C2 and the storage C3, a server, or another appropriate medium.

The communication apparatus C4 is hardware (transmission/reception apparatus) for performing communication between computers via at least one of a wired network and a wireless network, and is also referred to as, for example, a network apparatus, a network controller, a network card, a communication module, or the like. The communication apparatus C4 may include a high-frequency switch, a duplexer, a filter, a frequency synthesizer, and the like in order to realize, for example, at least one of frequency division duplex (FDD) and time division duplex (TDD). For example, each unit included in the above-described control units 2 and 2A may be realized by the communication apparatus C4. Furthermore, for example, in the DR communication unit 11, a reception function and a transmission function may be physically or logically separated.

The input apparatus C5 is an input apparatus (for example, a keyboard, a mouse, a microphone, a switch, a button, a sensor, or the like) that receives an input from the outside. The output apparatus C6 is an output apparatus (for example, a display, a speaker, an LED lamp, and the like) that performs output to the outside. Note that the input apparatus C5 and the output apparatus C6 may be integrated configuration (for example, a touch panel).

Furthermore, the respective apparatuses such as the processor C1 and the memory C2 are connected by the bus C7 for communicating information. The bus C7 may be configured using a single bus or may be configured using different buses for each apparatus.

Furthermore, the above-described control units 2 and 2A may include hardware such as a microprocessor, a digital signal processor (DSP), an application specific integrated circuit (ASIC), a programmable logic device (PLD), and a field programmable gate array (FPGA), and a part or all of each functional block may be realized by the hardware. For example, the processor C1 may be implemented by using at least one of these pieces of hardware.

The notification of information is not limited to the aspects/embodiments described in the present disclosure, and may be performed using other methods.

The order of the processing procedure, sequence, flowchart, and the like of each aspect/embodiment described in the present disclosure may be changed as long as there is no contradiction. For example, for the methods described in the present disclosure, elements of various steps are presented using an example order, and are not limited to the particular order presented.

The input/output information and the like may be stored in a specific location (for example, memory) or may be managed using a management table. The input/output information and the like can be overwritten, updated, or additionally written. The output information and the like may be deleted. The input information and the like may be transmitted to another apparatus.

The determination may be made by a value represented by one bit (0 or 1), may be made by a Boolean value (true or false), or may be made by comparison of numerical values (for example, comparison with a predetermined value).

Each aspect/embodiment described in the present disclosure may be used alone, or may be used in combination, or may be switched with execution. Furthermore, notification of predetermined information (for example, notification of “being X”) is not limited to being performed explicitly, and may be performed implicitly (For example, the predetermined information is not notified).

Although the present disclosure has been described in detail above, it is apparent to those skilled in the art that the present disclosure is not limited to the embodiments described in the present disclosure. The present disclosure can be implemented as modifications and variations without departing from the spirit and scope of the present disclosure defined by the claims. Therefore, the description of the present disclosure is for the purpose of illustration and does not have any restrictive meaning to the present disclosure.

Software, whether referred to as software, firmware, middleware, microcode, hardware description language, or other names, should be construed broadly to mean instructions, instruction sets, code, code segments, program code, programs, subprograms, software modules, applications, software applications, software packages, routines, subroutines, objects, executable files, execution threads, procedures, functions, and the like.

Furthermore, software, instructions, information, and the like may be transmitted and received via a transmission medium. For example, when software is transmitted from a website, server, or other remote source using at least one of a wired technology (a coaxial cable, an optical fiber cable, a twisted pair, a digital subscriber line (DSL), or the like) and a wireless technology (infrared rays, microwaves, etc.), at least one of these wired and wireless technologies is included within the definition of the transmission medium.

The information, signals, and the like described in the present disclosure may be represented using any of a variety of different techniques. For example, data, instructions, commands, information, signals, bits, symbols, chips, and the like that may be mentioned throughout the above description may be represented by voltages, currents, electromagnetic waves, magnetic fields or particles, optical fields or photons, or any combination thereof.

Note that the terms described in the present disclosure and the terms necessary for understanding the present disclosure may be replaced with terms having the same or similar meanings.

The terms “system” and “network” used in the present disclosure are used interchangeably.

Furthermore, the information, the parameter, and the like described in the present disclosure may be represented using an absolute value, may be represented using a relative value from a predetermined value, or may be represented using another corresponding information. For example, the wireless resource may be indicated by an index.

The names used for the parameters described above are not limited in any respect. Moreover, expressions and the like using these parameters may be different from those explicitly disclosed in the present disclosure. Since various information elements can be identified by any suitable name, the various names assigned to these various information elements are not in any way limitative names.

In the present disclosure, terms such as “base station (BS)”, “wireless base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, and “component carrier” can be used interchangeably. The base station may also be referred to as a macro cell, a small cell, a femto cell, a pico cell, or the like.

The terms “determining” used in the present disclosure may encompass a wide variety of actions. The terms “determining” may include regarding, for example, judging, calculating, computing, processing, deriving, investigating, searching (looking up, search, inquiry) (for example, searching in a table, a database, or another data structure), and ascertaining as “determining”. Furthermore, “determining” may include regarding receiving (for example, receiving information), transmitting (for example, transmitting information), input, output, and accessing (for example, accessing data in a memory) as “determining”. Furthermore, “determining” may include regarding have been performed on resolving, selecting, choosing, establishing, comparing, and the like as “determining”. That is, “determining” may include regarding some operation as “determining”. Furthermore, “determining” may be read as “assuming”, “expecting”, “considering”, or the like.

The terms “connected”, “coupled”, or any variation thereof, mean any direct or indirect connection or coupling between two or more elements, and can include the presence of one or more intermediate elements between two elements that are “connected” or “coupled” to each other. The coupling or connection between the elements may be physical, logical, or a combination thereof. For example, “connection” may be read as “access”. As used in this disclosure, two elements can be considered to be “connected” or “coupled” to one another using at least one of one or more wires, cables, printed electrical connections, and as some non-limiting and non-exhaustive examples, using electromagnetic energy having wavelengths in the radio frequency region, the microwave region, and the light (both visible and invisible) region, and the like.

As used in this disclosure, the phrase “based on” does not mean “based only on” unless explicitly stated otherwise. In other words, the description “based on” means both “based only on” and “based at least on”.

Any reference to elements using designations such as “first”, “second”, and the like as used in the present disclosure does not generally limit the amount or order of those elements. These designations may be used in the present disclosure as a convenient way to distinguish between two or more elements. Thus, reference to first and second elements does not imply that only two elements may be employed or that the first element must in any way precede the second element.

The “means” in the configuration of each device described above may be replaced with a “unit”, a “circuit”, a “device”, or the like.

Where the present disclosure uses the terms “include”, “including”, and variations thereof, these terms are intended to be inclusive in a manner similar to the term “comprising”. Moreover, the term “or” used in the present disclosure is intended not to be an exclusive OR.

In the present disclosure, for example, in a case where articles such as a, an, and the in English are added by translation, the present disclosure may include a case where a noun following these articles is a plural form.

In the present disclosure, the term “A and B are different” may mean “A and B are different from each other”. Note that the term may mean that “A and B are different from C”. Terms such as “leave”, “coupled” and the like may also be interpreted in the same manner as “different”.

### REFERENCE SIGNS LIST

1: electric power control system; 2, 2A: control unit; 10: server; 11: DR communication unit; 12: discharge electric power detection unit; 13: storage battery capacity detection unit; 14: storage unit; 15: duration calculation unit; 16: interval comparison unit; 17: base station selection unit; 18: discharge determination unit; 19: storage battery capacity update unit; 2A: control unit; 81: power saving amount prediction unit; 82: discharge electric power detection unit; 83: storage battery capacity detection unit; 84: storage unit; 85: duration calculation unit; 86: interval comparison unit; 87: base station selection unit; 88: discharge determination unit; 89: storage battery capacity update unit; 91: control amount measurement unit; 92: buffer station management unit; 93: correction unit.

1. An electric power control system comprising:
a plurality of consumers including a load, a rectifier, and a storage battery; and
a control unit configured to control the rectifier and the storage battery in the plurality of consumers,
the electric power control system performing a power saving operation in the plurality of consumers based on a power saving request,
wherein the control unit divides a time zone in which the power saving request is made into a plurality of unit times, selects a consumer to be subjected to power saving control from the plurality of consumers based on a power saving request amount per unit time, and performs a discharge operation from the storage battery in the selected consumer to respond to the power saving request.

2. The electric power control system according to claim 1, wherein the control unit acquires output electric power information of the rectifier and current capacity information of the storage battery in each of the plurality of consumers, and selects a consumer to be subjected to the power saving control based on these pieces of information.

3. The electric power control system according to claim 1, wherein the control unit selects the consumer to be subjected to the power saving control after securing a backup capacity of the storage battery in each of the plurality of consumers.

4. The electric power control system according to claim 1 wherein the control unit compares a control amount related to power saving among the plurality of consumers as a whole with the power saving request amount, and performs a discharge operation from the storage battery in a consumer different from the consumer responding to the power saving request in a case where the control amount is insufficient for the power saving request amount.

5. The electric power control system according to claim 4, wherein the control unit holds in advance information on a consumer different from the consumer responding to the power saving request and capable of performing a discharge operation from the storage battery, and selects a consumer performing the discharge operation from the storage battery based on the information in a case where the control amount is insufficient for the power saving request amount.

6. The electric power control system according to claim 1, wherein the power saving request is a request for responding to a demand response request.

7. The electric power control system according to claim 1, wherein the power saving request is a request for reducing a demand peak based on a prediction of electric power demand.

8. The electric power control system according to claim 2, wherein the control unit selects the consumer to be subjected to the power saving control after securing a backup capacity of the storage battery in each of the plurality of consumers.
